(19) United States
(12) Patent Application Publication
(10) Pub. No.: US 2023/0339526 A1
(43) Pub. Date: Oct. 26, 2023

(54) INTERSECTION MANAGEMENT SYSTEM

(71) Applicant: Transportation IP Holdings, LLC, Norwalk, CT (US)

(72) Inventors: Jeffrey D. Kernwein, Cedar Rapids, IA (US); Larry Chalmers, Jacksonville, FL (US); Brad Von Tersch, Jacksonville, FL (US); Jeremy Blackwell, Cedar Rapids, IA (US); James Lucas, Wilmerding, PA (US); Michael Kirchner, Jacksonville, FL (US); Stuart J. Barr, Cedar Rapids, IA (US); Victor Cornejo, Cedar Rapids, IA (US); James D. Brooks, Schenectady, NY (US); Hullas Sehgal, Niskayuna, NY (US); Harry Kirk Mathews, Jr., Clifton Park, NY (US)

(21) Appl. No.: 18/334,141

(22) Filed: Jun. 13, 2023

Related U.S. Application Data
(63) Continuation-in-part of application No. 17/890,192, filed on Aug. 17, 2022.
Application No. 17/890,192 is a continuation-in-part of application No. 16/733,465, filed on Jan. 3, 2020, now Pat. No. 11,468,766.
Application No. 16/733,465 is a continuation-in-part of application No. 18/312,804, filed on May 5, 2023.
Application No. 18/312,804 is a continuation-in-part of application No. 17/315,836, filed on May 10, 2021, now Pat. No. 11,691,656.
Application No. 17/315,836 is a continuation of application No. 16/263,870, filed on Jan. 31, 2019, now Pat. No. 11,008,029.
Application No. 16/263,870 is a continuation-in-part of application No. 15/705,752, filed on Sep. 15, 2017, now Pat. No. 10,246,111.
Application No. 15/705,752 is a continuation of application No. 15/061,212, filed on Mar. 4, 2016, now Pat. No. 9,764,748.
Application No. 15/061,212 is a continuation-in-part of application No. 17/889,716, filed on Aug. 17, 2022.
(60) Provisional application No. 62/281,429, filed on Jan. 21, 2016.

(51) Int. Cl. B61L 23/34; B61L 25/02; B61L 23/00; B61L 3/00

(52) U.S. Cl. CPC B61L 23/34; B61L 25/025; B61L 23/007; B61L 3/008; B61L 25/021; B61L 2205/04; B61L 15/0009

(57) ABSTRACT

An intersection management system and method for reducing or avoiding potential collisions between vehicles are provided. The system may use a wireless signal, with or without a circuit, to traverse an intersection. The system may use, at least in part, a positive vehicle control system.

### CROSS-REFERENCE TO RELATED APPLICATIONS

This application is a Continuation-in-Part and claims priority to U.S. patent application Ser. No. 17/890,192 (filed 17 Aug. 2022), which is a Continuation-in-Part of U.S. patent application Ser. No. 16/733,465 (filed 3 Jan. 2020, now U.S. Pat. No. 11,468,766); and to U.S. patent application Ser. No. 18/312,804 (filed 5 May 2023), which is a Continuation-in-Part of U.S. patent application Ser. No. 17/315,836 (filed 10 May 2021), which is continuation of U.S. patent application Ser. No. 16/263,870 (filed 31 Jan. 2019, issued as U.S. Pat. No. 11,008,029), which is a continuation-in-part of U.S. patent application Ser. No. 15/705,752 (filed 15 Sep. 2017, issued as U.S. Pat. No. 10,246,111), which is a continuation of U.S. patent application Ser. No. 15/061,212 (filed 4 Mar. 2016, issued as U.S. Pat. No. 9,764,748), which claims priority to U.S. Provisional Application No. 62/281,429 (filed 21 Jan. 2016); and this application is a Continuation-in-Part and claims priority to U.S. patent application Ser. No. 17/889,716 (filed on 17 Aug. 2022); the entire disclosures of which are incorporated herein by reference.

### BACKGROUND

### Technical Field

The subject matter described relates to systems and methods that monitor, manage and/or control route crossings and intersections.

Discussion of Art.

A variety of vehicles travel on routes that may cross or intersect each other, or otherwise be positioned, such that certain locations of the routes have an increased risk of collision between vehicles. One example of such a location is a crossing system or intersection between routes, such as between a track of a rail vehicle and a road.

Some known detection systems use direct current (DC) circuits coupled with conductive portions of a route in locations on both sides of an intersection or crossing system. These conductive circuits are referred to as islands. As a pair of conductive wheels coupled by a conductive axle (e.g., a wheel-axle set) of a vehicle passes over the circuit, the wheels and axle form a short in the circuit, which is used to detect approach of the vehicle toward the intersection or the crossing system. There may be a couple of these circuits on each side of the intersection, with the farthest circuits away from the intersection being referred to as an approach circuit and the circuits closer to the intersection being referred to as island circuits.

Other known crossing system systems may activate safety devices responsive to expiration of a delay after detection of the wheel-axle set at the detection circuit. For example, a gate may be lowered, lights may be activated, a horn may be activated, etc., after expiration of a ten second delay following detection of a vehicle approaching the crossing system by a detection circuit. These known systems may detect a completed pass-through of a vehicle or multi-vehicle system moving through the crossing system responsive to the island circuit detecting that the last wheel-axle set of the vehicle or vehicle system has left an island area. The safety devices may be deactivated following expiration of the same or another delay following detection of the last axle of the vehicle or vehicle system past the island circuit.

These known detection circuits may degrade over time and may fail to detect the axle of a vehicle approaching the crossing system. The circuits may not detect the short (caused by the electrically conductive axle) until after the first wheel-axle set passes through or over the circuit. Instead, another wheel-axle set (e.g., the third, fifth, etc., wheel-axle set) may be detected. As a result, the safety devices may be activated too late (e.g., the vehicle may be within or too close to the crossing system to provide adequate notice to others in the crossing system to avoid a collision). Additionally, some types of vehicles may have wheel-axle sets that may not consistently or reliably provide a short in the detection circuit that can be detected by the detection circuit. As a result, these vehicles may not be detected by the circuits.

Some known systems detect the presence of an automobile in a crossing system using radar and provide notices to railroad personnel. But these notices may be missed by the personnel. Further, depending on the distance of a vehicle to the crossing system, there may be a relatively large number of false positives that may inhibit efficiency of a crossing system or detection system or its use. It may be desirable to have a system and method that differs from those that are currently available.

### BRIEF DESCRIPTION

In one example, a method is provided that includes receiving a wireless signal indicative of one or more of a location, a heading, or a moving speed of a first vehicle; predicting a time of arrival of the first vehicle at an intersection based at least in part on the signal received; and activating at least one of a barrier and a notification at a time in a determined range of times prior to the predicted time of arrival, and thereby to prevent, warn or block a second vehicle from entering the intersection.

In one example, a system is provided that includes a controller onboard a first vehicle. The controller can attempt to establish a communication connection with a communication device of a crossing system disposed proximate to an intersection. The controller can send a wireless signal indicative of one or more of a location, a heading, or a moving speed of the first vehicle. The controller can, at least one of, obtain confirmation from the communication device that the crossing system is functioning properly and is acting, or will act, to prevent any second vehicle from being in the intersection at the time of arrival; obtain information from the communication device that the intersection is obstructed, or will be obstructed at the time of arrival; and determine a time of arrival of the first vehicle at the intersection, and slow or stop the first vehicle prior to entering into the intersection if the communication connection is not established.

In one example, a system is provided that includes a controller. The controller has one or more processors that are disposed onboard a first vehicle. The controller can determine a location, heading or speed of the first vehicle based at least in part on a positive train control track database. The system includes a crossing system that can receive data wirelessly from the controller, and to activate a barrier and/or notifications at a determined time prior to an arrival of the first vehicle at an intersection proximate to the crossing system. A wireless communication system can provide a communication connection between the controller and the crossing system. One or both of the controller and crossing device can determine the time of arrival of the first vehicle at the intersection based at least in part on the location, heading and/or speed of the first vehicle.

### BRIEF DESCRIPTION OF THE DRAWINGS

The inventive subject matter may be understood from reading the following description of non-limiting embodiments, with reference to the attached drawings, wherein below:

FIG. 1 illustrates a block schematic diagram of a network that may include an obstruction alert system, a wayside detection system, and a vehicle;

FIG. 2 illustrates an example crossing system of the network of FIG. 1;

FIG. 3 illustrates a plurality of wayside camera assemblies located at several different crossing systems between routes;

FIG. 4 illustrates one example of a wayside camera assembly for the network of FIG. 1; and

FIG. 5 illustrates a flowchart of one example of a method for detecting an obstruction of a route.

### DETAILED DESCRIPTION

Embodiments of the subject matter described herein relate to systems and methods that determine a state of a crossing system and the operation of one or more vehicles relative to the crossing system. In one embodiment, may notify vehicles approaching the crossing system of an incoming vehicle along another route. The system may determine whether an obstruction is present or may be present in an intersection between two or more routes and may respond and/or notify the first incoming vehicle, or may notify and/or block the second incoming vehicle. One or both of the vehicles can change movement to avoid colliding. That is, one may stop at the crossing gates as the other vehicle continues through without stopping.

In various embodiments, an onboard system may control movement of a vehicle system on a route relative to another vehicle that is moving towards the same intersection. For example, the onboard system paces the vehicle system based at least in part on an acceleration (or deceleration) capability of the vehicle ahead such that the vehicle system does not travel within a designated range/distance of the vehicle ahead. This may require the vehicle system to stop or at least slow to increase the distance between the vehicles. In another example, the onboard system may pace the vehicle system such that it arrives at the intersection at a different time than the other vehicle. In another example, the vehicle interacts with crossing system signal equipment at the upcoming intersection. The crossing system equipment may activate and lower a crossing system barrier for a route, or may signal back that one incoming vehicle or another must slow or stop. In one embodiment, a positive vehicle control system (such as a positive train control system, PTC) may control the translation of the vehicle system to and/or through the intersection.

In various embodiments, an onboard system can control movement of a vehicle system on a route relative to an upcoming grade crossing system. For example, the onboard system may operate an externally audible notice automatically (without operator input) as the vehicle system approaches the grade crossing system. The notice may be visual. The characteristics of the notice, such as whether or not to activate the notice, the volume or intensity of the notice, the start and end times of the notice, etc., are controlled by the onboard system.

Various other embodiments described herein provide an onboard system that can control movement or braking of a vehicle system on a route relative to work zones and other special areas of interest along the route. For example, the onboard system may automatically update a trip plan according to which the vehicle system is traveling based on a received order, such as a temporary slow order or a different set of pathways to define a new route.

The onboard system may automatically display information to an operator of the vehicle system. For example, the onboard system may display (on an onboard visual display) information about a route aspect, such as an upcoming crossing system/intersection with crossing system equipment. The information for an upcoming crossing system may include a distance to the crossing system, a time of arrival to the crossing system, a status of the crossing system equipment (e.g., red over green indication, red over yellow indication, or green over green indication), the aspect of the crossing system (e.g., approach medium, clear, etc.), a type of the crossing system equipment, and a physical layout of the crossing system.

The onboard system may determine the location of a vehicle along with speed and provide the location and speed to a control system at a determined rate. A suitable location determination may include latitude and longitude information, and/or may contain a distance relative to a known reference point, such as a beacon, mile marker, or infrastructure. A suitable control system may include a positive vehicle control system, such as I-ETMS positive train control system available from Wabtec Corporation. A suitable determine rate may be, for example, one sample per second (1 Hz). A control system may then calculate the amount of time for any vehicles in a network associated with the control system to arrive at any crossing systems identified as obstructed. In various embodiments, an escalating scale of alerts may be provided to a dispatcher and/or operator based on the amount of time a particular object has obstructed a crossing system and the estimated time of arrival of the vehicle to the crossing system.

In one example, the systems and methods integrate the detection or prediction of the obstruction with a centralized control system that can notify vehicles equipped with positive train control systems, and the onboard positive train control systems can automatically apply brakes to slow or stop movement of the vehicle before the vehicle collides with the obstruction. The systems and methods described herein can be used with rail vehicle systems equipped with an onboard positive train control system. The systems and methods described herein may be used with other control systems, such as negative control systems. Stationary wayside sensors may detect the presence of a vehicle within a crossing system between a track and a road, for example, and alerts and/or commands provided to the vehicle as appropriate.

Not all embodiments described herein are limited to rail vehicle systems, positive vehicle control systems, cameras, crossing systems between routes, slowing or stopping as a responsive action, and/or automobiles as obstructions in a crossing system. For example, one or more embodiments of the systems and methods described herein can be used in connection with other types of vehicles, such as automobiles, trucks, buses, mining vehicles, marine vessels, aircraft, agricultural vehicles, or the like. The systems and methods can notify these other types of vehicles of obstructions to prevent collisions between the vehicles and the obstructions. As another example, one or more embodiments can be used with vehicle control systems other than positive train control systems to change movement of a vehicle responsive to receiving a notice of an obstruction.

Additionally, one or more embodiments may use sensors other than cameras to detect an obstruction. For example, radar systems, lidar systems, weight scales, or the like, may be used to detect obstructions. The obstructions may be detected in locations other than crossing systems (e.g., intersections) between two or more routes. For example, one or more embodiments described herein may be used to detect an obstruction along a route in a location that is not a crossing system between the route and at least one other route. The onboard control systems may implement a responsive action other than slowing or stopping movement of the vehicle responsive to receiving a notice of an obstruction. For example, the onboard control systems may change which route the vehicle is traveling on to avoid colliding with the obstruction.

The crossing system equipment may notify determined vehicles when an obstruction will or may exist, but that does not yet exist. For example, the locations, headings, and/or speeds of vehicles can be examined and used to predict when one or more vehicles will be present in an intersection (even though no vehicle may currently be in the intersection). The systems can notify other vehicles of the potential presence of a vehicle in the intersection at the times that the other vehicles may be in the intersection. The vehicles approaching the intersection may then slow or stop, or change direction, to avoid a collision in the intersection.

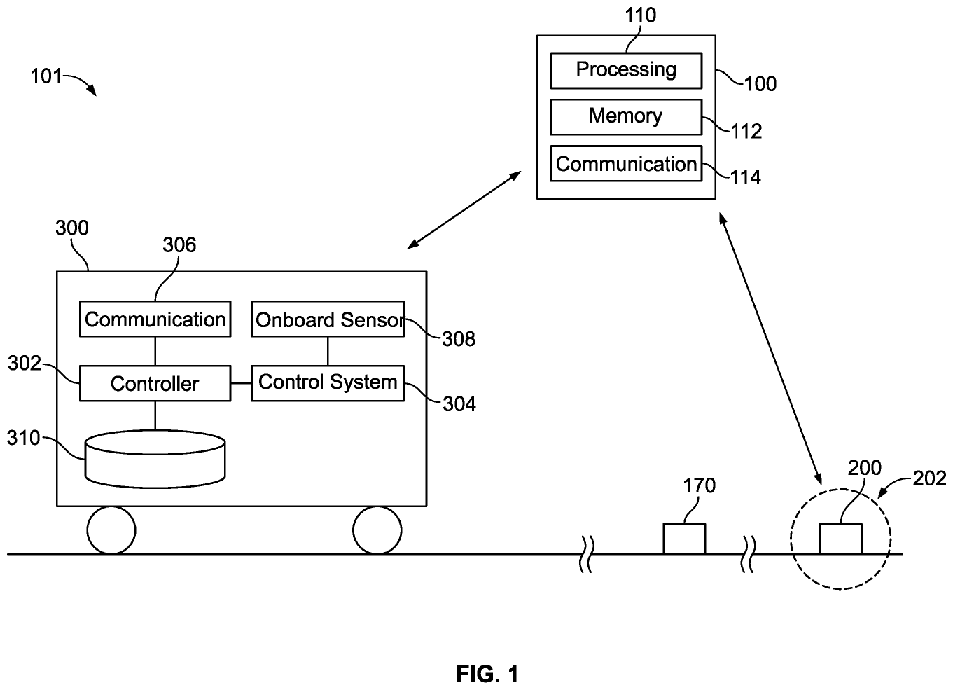

FIG. 1 illustrates a block schematic diagram of a network 101 that may include a back office system 100, a wayside crossing system 200, and a vehicle 300. In the illustrated example, the control, storage, analytics and decisioning are shown as a remote back-office application. In various embodiment, some or all of those back-office functions may be performed on the vehicle and/or by the crossing system. An onboard position sensor 308 of the vehicle may provide information to determine a presence or absence of a risk level (of obstruction and/or collision) and may perform (e.g., direct performance of) a responsive activity responsive to determination of the presence of a risk level and/or its magnitude or likelihood.

The vehicle may include a controller 302 that represents one or more processors that control movement and other operations of the vehicle. This controller can be referred to as a vehicle controller. The vehicle controller can represent an engine control unit, an onboard navigation system, or the like, that can control a propulsion system (e.g., one or more engines, motors, etc.) and/or a braking system (e.g., one or more friction brakes, air brakes, regenerative brakes, etc.) to control movement of the vehicle.

The vehicle optionally may include a control system 304 that communicates with one or more off-board control systems (e.g., the obstruction alert system and/or a system including or associated with the obstruction alert system) for limiting where and/or when the vehicle can move. For example, the control system onboard the vehicle can be referred to as a vehicle control system that can automatically apply brakes of the vehicle to slow or stop the vehicle based on notice bulletins received from the obstruction alert system. In one embodiment, the vehicle control system is an onboard component of a positive train control system that limits where and when the vehicle can move based on movement authorities, locations of other vehicles, or the like.

Communications from the crossing system obstruction alert system can be received by the vehicle controller and/or vehicle control system via a communication device 306, which may also provide information from the position sensor to the crossing system obstruction alert system. This communication device can include an antenna and wireless transceiving circuitry that wirelessly communicates signals with other communication devices described herein. A tangible and non-transitory computer-readable storage medium (e.g., a memory 310) of the vehicle may store locations and/or layouts of the routes, locations of the monitored areas, identities of the camera assemblies and the monitored areas examined by the camera assemblies, etc.

The vehicle control system can receive alerts, commands, or other messages sent from the crossing system obstruction alert system and/or other off-board control system and can apply the brakes of the vehicle and/or control the propulsion system of the vehicle to slow or stop movement of the vehicle responsive to receiving the notice bulletin. For example, the onboard positive train control system of the vehicle can receive a message corresponding to an obstruction in a crossing system. The onboard positive train control system can then notify an onboard operator to engage the brakes or can automatically apply the brakes to prevent a collision between the vehicle and the obstruction. Alternatively, the vehicle control system in some embodiments is not a positive train control system. The vehicle control system can receive the notice bulletin or signal from the off-board control system and engage the brakes or otherwise act to slow or stop movement of the vehicle.

The depicted example vehicle may include one or more position sensors that determine locations and/or headings of the vehicles. The position sensor can represent a global positioning system receiver, a wireless triangulation system, a dead reckoning system, inertial sensor, speedometer, or the like, that determines locations and/or headings of the vehicle. The locations and/or headings of the vehicles can be determined by the position sensors and communicated from the vehicles to the crossing system obstruction alert system.

As discussed herein, position information may be used to determine the proximity of a particular vehicle to a particular crossing system associated with an obstruction. The position information may be used to identify or select which vehicles among a group of vehicles should be analyzed for determining proximity information. For example, a notice signal received by the crossing system obstruction alert system from the optical sensor can identify the location of the monitored area where the obstruction is detected and/or can identify the camera assembly that detected the obstruction. The locations of the camera assemblies can be associated with different monitored areas, and the crossing system obstruction alert system can determine the location of the obstruction from the notice signal and/or the identity of the camera assembly that sent the notice signal. Then, the crossing system obstruction alert system can determine which, if any, vehicles are sent an alert or other message or command.

In some examples, the obstruction alert system may be understood as including or incorporating the optical sensor and the position sensor. In other embodiments, the obstruction alert system may be understood as separate from the optical sensor and the position sensor and can receive information from the sensors. The depicted example obstruction alert system may include a controller, memory 112, and communication unit 114. The communication unit can exchange messages or information with aspects of the crossing system and the vehicle. For example, the communication unit may be used to receive information from the optical sensor and the position sensor, and/or to provide messages (e.g., alerts, commands, or other information) to the vehicle. In some embodiments, the obstruction alert system forms a portion of a back-office server of a positive train control (PTC) system. Alternatively, the obstruction alert system can form a part of another system that monitors movements of the vehicles to ensure safe travel of the vehicles. For example, the obstruction alert system may be a portion of or associated with a dispatch facility, a scheduling facility, or the like.

Generally, the controller represents one or more processors configured (e.g., programmed) to perform various tasks or activities discussed herein. For example, the depicted example controller can obtain or receive position information (e.g., information indicating a position of the vehicle traversing a route) from the position sensor, and to receive crossing system obstruction information (e.g., information indicating a presence of an obstruction to the crossing system) from the optical sensor. The controller can determine proximity information of the vehicle 300 indicating proximity of the vehicle to the crossing system using the position information. Further, the controller can determine a presence or absence of a risk level indicating a potential of the crossing system being obstructed using the crossing system obstruction information and the proximity information, and perform a responsive activity responsive to a determination of the presence of the risk level being greater than a determined threshold value.

A suitable controller represents hardware circuitry that may include and/or is connected with one or more processors (e.g., one or more microprocessors, integrated circuits, microcontrollers, field programmable gate arrays, etc.) that perform operations described herein. The controller in various embodiments stores acquired information (e.g., information regarding the location of crossing systems, information regarding the position of one or more vehicles, information regarding identified obstructions to one or more crossing systems) in a tangible and non-transitory computer-readable storage medium (e.g., memory). Additionally or alternatively, instructions for causing the controller to perform one or more tasks discussed herein may be stored in a tangible and non-transitory computer-readable storage medium (e.g., memory).

As discussed herein, the controller may receive crossing system obstruction information from the optical sensor. The crossing system obstruction information may include information describing the presence of an obstruction at a crossing system, the type of obstruction (e.g., car), and/or an amount of time for which the obstruction has been in the crossing system. The crossing system obstruction information may also include an identification of the particular crossing system and/or location of the crossing system for which an obstruction has been detected.

The controller may obtain the position information from the position sensor. The position information indicates a position of the vehicle traversing a particular route (e.g., a route on which a crossing system is disposed along). The position information in various embodiments is obtained from a location signal communicated from onboard the vehicle (e.g., from communication device providing information from position sensor). The position information in various examples may include information describing a current location of the vehicle (e.g., a geographical location and/or an identification of a particular route on which the vehicle is disposed) and/or movement information (e.g., a speed travelled by the vehicle and a direction of travel). In some examples, the controller may receive position information at determined time intervals for a given vehicle to monitor and update a determined position of the vehicle and/or to determine a speed of the vehicle.

The controller can determine proximity information of the vehicle. The proximity information indicates a proximity of the vehicle to a particular crossing system (e.g., a crossing system for which the controller has received obstruction information indicating an obstruction at the crossing system). For example, the proximity information may include a distance of the vehicle from an obstructed crossing system. In some embodiments, the proximity information may include an estimated time of arrival for the vehicle at the crossing system. For example, the controller in some examples determines an estimated time of arrival using the position information and an estimated speed of the vehicle. By knowing the geographical position of the vehicle from the position information, as well as the geographical position of the crossing system from archived information, a distance from the vehicle to the crossing system may be determined. The distance may be in terms of a distance between coordinates of the vehicle and the crossing system, or, as another example, may be in terms of mileposts or other measurements of distance along a particular route. With the distance and speed known, a time of arrival (e.g., an elapsed time from a current time) may be estimated or determined.

Various different estimated or measured speeds may be used in determining the time of arrival. In one example, the position information may include a current speed of the vehicle (e.g., as measured by a speedometer of the vehicle), which may be used to determine an estimated time of arrival. In another example, the estimated speed of the vehicle is determined using a plurality of location signals received from the vehicle. For example, by determining the locations at various times along with the amount of times between readings, the controller may estimate a speed of the vehicle. Additionally or alternatively, non-measured information may be used to estimate the speed. For example, a determined upper speed limit of the vehicle may be used. As another example, a speed of the vehicle as called for by a trip plan may be used. In some embodiments, multiple speeds may be estimated (e.g., one speed using a current measured speed, a second speed using a planned speed, a third speed using a historical average of similar vehicles on similar routes), and the highest speed used to determine the estimated time of arrival.

Using the crossing system obstruction information and the proximity information, the controller may determine a presence or impending presence in a determined zone. An impending presence may presage a potential collision at the crossing system. Various factors may be considered individually or in combination to help determine the presence or absence of risk level. For example, the closer the vehicle is to the crossing system may be used to increase the likelihood of a risk level and/or increase the level of a risk level. As another example, the shorter the estimated time to arrival may be used to increase the likelihood of a risk level and/or increase the level of a risk level. As one more example, the longer amount of time that an obstruction has remained in the crossing system may be used to increase the likelihood of a risk level and/or increase the level of a risk level. For example, in some embodiments, the risk level being greater than a determined threshold value indicates that the vehicle is within a threshold time (or distance) for which one or more alerts are appropriate. Accordingly, alerts or other messages or commands may be sent when appropriate, but false or unnecessary alarms for crossing system located a sufficient distance away may be avoided. Responsive to a determination of the presence of the risk level being greater than a determined threshold value, the controller performs a responsive activity. If the risk level for a potential collision is determined to be less than a threshold value for a current position of a vehicle, no immediate action may be taken, but the position of the vehicle may be periodically updated and the estimated arrival time updated and monitored, with an alert or other responsive step taken subsequently as appropriate based on the updated and monitored position of the vehicle.

Various types of responsive actions may be taken in different embodiments. For example, an alert or other message may be sent to the vehicle for review and/or implementation by an operator. As another example, crossing system equipment 170 may be disposed along the route, and the responsive activity may include operating the crossing system equipment. For instance, the crossing system equipment may provide a visual display to an operator of the passing vehicle, and the controller may send a control signal to the crossing system equipment to display an appropriate notice. As another example, the crossing system equipment may be associated with a switch, and the controller may send a control signal to the crossing system equipment to operate the switch and transfer the vehicle to a different track for which there is no upcoming obstructed crossing system. As one more example, the controller may perform a responsive action of sending a control signal to the vehicle that causes a change in the operation of the vehicle (e.g., reduction of throttle, application of brakes). In some examples, the responsive activity may include transmitting a signal to the vehicle that over-rides a current operation of the vehicle.

The risk level being greater than a determined threshold value may include a variety of alert levels. For example, the controller may determine an alert level using the proximity information and the crossing system obstruction information responsive to determining the presence of a risk level. The alert level may be selected from a group of different hierarchically-ranked alert levels. For example, a higher or more immediate alert level may be selected based on a relatively shorter estimated arrival time and/or a relatively longer duration of obstruction, while a lower or less immediate alert level may be selected based on a relatively longer estimated arrival time and/or a relatively shorter duration of obstruction.

Further, the responsive activity may be selected by the controller from different hierarchically-ranked remedial activities corresponding to the hierarchically ranked alert levels. In one example, for a first, lowest level alert, an informational message may be sent to an operator. The informational message, for example, may identify an upcoming crossing system that is obstructed along with a distance to the crossing system or estimated time of arrival. For a second, intermediate level alert, a command message may be sent, instructing the operator to perform one or more steps to slow the vehicle and/or alter a course of the vehicle. For a third, higher level alert, a command signal may be sent to the vehicle to autonomously implement a corrective action to slow the vehicle and/or alter a course of the vehicle without operator intervention. For example, an alert level may represent a risk of collision, with responsive activities selected as appropriate for the level of risk of collision. For example, if an expected risk of collision is 100%, then full braking may be automatically implemented, or the vehicle may be diverted to another route. As another example, if an expected risk of collision is 20%, a dispatcher or operator may be ordered to consider additional information (e.g., information on a monitor) and decide on an action.

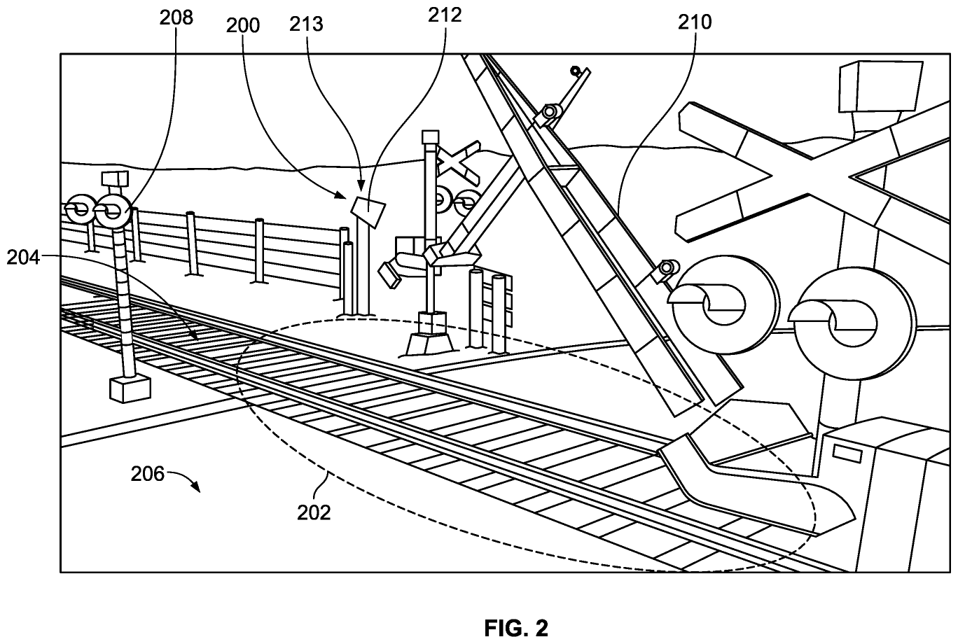

A system and related aspects are illustrated in detail in FIG. 2. A wayside system may be disposed at a crossing system or intersection 202 between two or more routes 204, 206. The crossing system can be an intersection between the routes. The crossing system can include one or more crossing system equipment or signals 208, gates 210, or the like. As discussed herein, a sensor package may include an optical sensor 212 and may be disposed proximate a crossing system of a route traversed by the vehicle and can obtain crossing system obstruction information indicating a presence of an obstruction to the crossing system.

Suitable routes can be tracks, roads, or the like, on which vehicles travel. In one example, the intersection may be between routes of the same type of route (e.g., an intersection between tracks, an intersection between roads, an intersection between mining vehicle routes, etc.). In another example, the intersection may be between routes of different types of routes (e.g., an intersection between a track and a road). The crossing system equipment may include lights that are activated to notify vehicles traveling on one route of a vehicle approaching on another route. The gates may be lowered to impede entry of a vehicle into the crossing system when another vehicle (e.g., a train) is approaching the crossing system.

The crossing system may include the optical sensor. A suitable optical sensor may be a wayside camera assembly 213, as in the illustrated example. The camera assembly may generate image data of the crossing system. The camera assembly can be stationary in that the camera assembly does not move while the vehicles moving on the routes pass by the camera assembly. In other embodiments, the camera assembly (and/or other sensors discussed herein) may be mobile. For example, the camera assembly may be mounted on another vehicle, or as another example, the camera assembly may be mounted on a drone. The camera assembly may include one or more cameras having a field of view that may include the routes and/or crossing system. The cameras can output data signals indicative of one or more characteristics of the routes and/or crossing systems. For example, the cameras can generate image or video data that is analyzed (e.g., by a controller of the camera assembly) to determine whether the image or video data indicate that a vehicle is obstructing the crossing system. This controller can generate a notice signal responsive to detecting the presence of an obstruction in the crossing system based on the image or video data. This notice signal optionally can be referred to as a notice bulletin. The notice signal can be communicated to a centralized location, such as a back-office server, which is off-board the vehicles traveling on the routes. The notice signal can be received by the centralized location. The centralized location can include a controller 110. The controller may determine which vehicles are near and/or approaching the crossing system, and/or how long a vehicle or other obstruction has been at a crossing system. The controller may be at a centralized location and can determine the appropriateness of further action, and perform a responsive activity (e.g., send the same or different notice signal (e.g., wirelessly) to the vehicles that are near and/or approaching the crossing system to notify these vehicles of the detected obstruction). Onboard control systems of the vehicles can apply brakes or otherwise change movement of the vehicles to slow or stop movement of the vehicles before the vehicles collide with the obstruction.

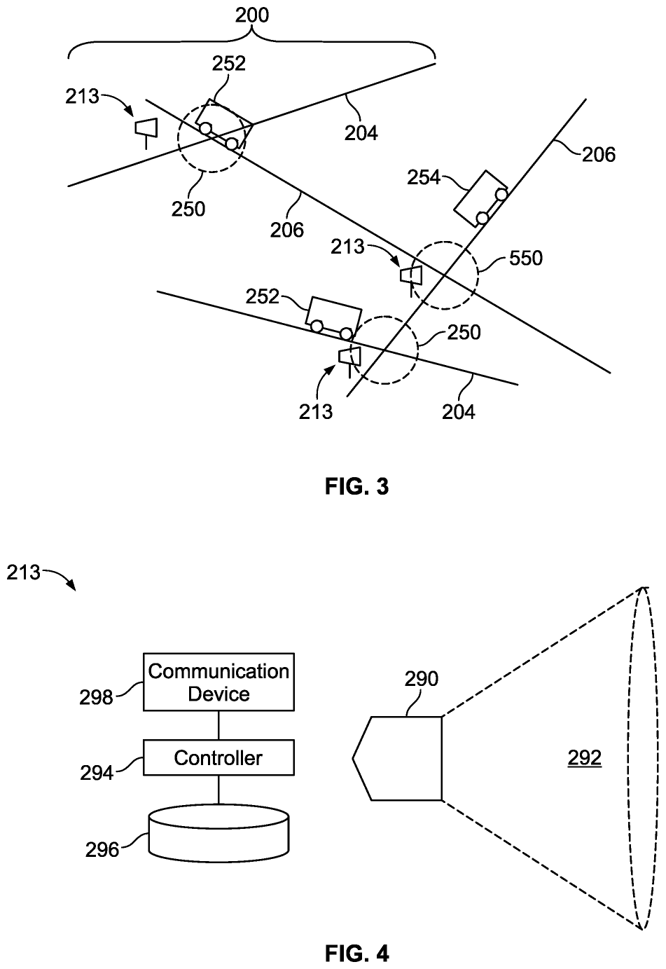

While only one crossing system is shown in FIG. 2, the crossing system may be used with several crossing systems. For example, FIG. 3 illustrates the crossing system communicating with several wayside assemblies located at several different crossing systems between routes. Each of the wayside assemblies can monitor characteristics of a different segment or portion of a route for an obstruction. For example, each wayside camera assembly can output and examine image and/or video data of a different crossing system to determine whether an obstruction is present in the crossing system. The wayside camera assembly can examine the characteristics of the route (e.g., the presence of an obstruction within a designated monitored area 250). This monitored area can correspond to a defined or fixed distance from the center of the crossing system, can correspond to the field of view of the camera assembly, or can otherwise be defined by an operator. If the data output by the camera assembly indicates that an obstruction is present within the monitored area, then the camera assembly can determine that an obstruction is present.

The obstruction that is detected can be the presence of a vehicle 252 and/or 254 within the monitored area. In one embodiment, one vehicle can be an automobile while the other vehicle can be a rail vehicle. Suitable rail vehicles may be a locomotive, a rail car, a train (combination of locomotive(s) and rail car(s)), or the like. Suitable vehicles can include other vehicles, such as both being automobiles or one or more of the vehicles representing buses, trucks, agricultural vehicles, mining vehicles, aircraft (e.g., manned or unmanned aircraft that may travel individually or in a group, such as one or more swarms), marine vessels, or the like. The routes can represent tracks, roads, waterways, mining paths or tunnels, airway paths, or the like.

An island 550 at the intersection of two routes is a conductively circuited crossing system. In this example, the approaching vehicle establishes a wireless connection with a wayside communication device described in more detail with reference to FIG. 4. If the handshake connection is not established, then the approaching first vehicle slows until either the vehicle stops, or the handshake connection is established. Once a handshake connection is established the system calculates, determines or predicts a time of arrival of the vehicle at the intersection. The wayside system's controller responds at determined time period by, for example, notifying other vehicles on the intersecting route that the first vehicle is approaching (by direct communication, by flashing lights, by ringing a bell or sounding a horn, and the like) and further may activate a barrier to block or prevent entry to the intersection. The timing of notifications and barrier placement may be determined by the controller based on threshold values, and sensor data input. Once the axle of the first vehicle enters the island (defined by the placement of the conductive circuit) the wayside device has supplemental confirmatory data on the location, distance, speed, direction of the first vehicle as it approaches the intersection. The wayside device controller may select which data set to use, may weigh the data set if there is a discrepancy, or may select the most conservative values in the event of a data discrepancy. For example, if the wireless system indicates that the vehicle is one mile away and moving at 60 miles per hour, and the circuit indicates that the vehicle is ¼ miles away and moving at 70 miles an hour, the controller may choose to act using the second data set (vehicle is closer and moving faster) and so responds more sooner and more quickly. Further, the vehicle may pass through the island with the end of train being clearing the intersection. That the end of the train has actually cleared the intersection is determined by an optical system, the conductive circuit, GPS signal transmitted from and End of Train device, and/or from the wireless signal from the first vehicle (having cleared the track well before the end of train clears the intersection). The wireless signal from the first vehicle may be calculated by a controller on the first vehicle. It may be determined, in one example, by locating the first vehicle (e.g., via a GPS receiver) and then calculating the length of the train via the train manifest stating how many cars are attached to the first vehicle. The calculation takes into account slack or compression to identify a probable range in which the actual end of train may be located (and then take the conservative outer envelope value).

In another embodiment, not shown, a system like that described in the preceding paragraph is provided except that no conductive track circuit is available. As such, the first vehicle approaches the intersection and attempts to establish communications with the co-located wayside communication device. If the handshake connection is not established, then the approaching first vehicle slows until either the vehicle stops, or the handshake connection is established. Once a handshake connection is established the system calculates, determines or predicts a time of arrival of the first vehicle at the intersection. The wayside system's controller responds by, in a determined time period, notifying other vehicles on the intersecting route that the first vehicle is approaching (by direct communication, by flashing lights, by ringing a bell or sounding a horn, and the like) and further may activate a barrier to block or prevent entry to the intersection. The timing of notifications and barrier placement may be determined by the controller based on threshold values, and sensor data input. In one embodiment, the wayside system receives a location and speed of the first vehicle and calculates a time of arrival (ToA), and then responds in advance of that ToA. The first vehicle may provide the wayside system with other data to use in calculating the ToA and/or the response to the impending arrival of the first vehicle. Other data may include factors such as the braking capacity of the first vehicle, the state of the tracks, other vehicle related factors, and the like. A controller on the first vehicle may determine braking distance based on brake health, brake type and the like; on track information (grade, condition, weather); and on factors such as vehicle or engine speed, number of rail cars, empty/full state of rail cars, type of rail cars, and type of cargo in rail cars. Some types of cargo (e.g., hazardous cargo) may cause the system to have a more cautious approach to the upcoming crossing than other cargo types. In another embodiment, the vehicle calculates the ToA and sends it to the wayside system. Regardless of where the ToA is calculated it may be updated at a determined rate, and recalculations may be triggered by determined events (such as application of brakes, a change in the power to the motors, and the like).

In one embodiment, the wayside system's controller may determine when the end of the train has vacated the island, and thus cleared the intersection. In response, the wayside system may stop activities indicated obstruction of the intersection—such as opening barriers, stopping horns and lights, and the like. The controller may determine a length of the train (from head to tail), may deduce slack or compression state based at least in part on the determined length of the train, may deduce number of rail cars and/or locomotives in the train, may diagnose malfunctions of various sensors involved in the process, and may communicate with other crossing systems. In embodiments where multiple crossing systems are involved, a train length may be longer than the distance between one crossing system to the next. In such a case, the first encountered crossing system may relay information to the second crossing system. Relayed information may include that a first vehicle is approaching, the speed and position, the length of train, the time the end of train clears the first crossing station, and other analytical data regarding the train.

With regard to technical effects, in various embodiments, the crossing system may manage gate operations for near station operations, manage variable train speeds for optimized crossing activations, reduce or prevent early arrivals of trains that are accelerating towards a crossing or intersection, reduce activation failures as health monitoring integrated with onboard systems, reduce track circuit issues—loss of shunt, salted crossing approaches, inductive interference, e.g., report whether crossing is connected giving real time reporting capabilities, and eliminate the need for disabling of a crossing system for track work (i.e., a circuitless crossing system would have no circuit to disable). Some of the systems disclosed herein may reduce track maintenance by eliminating circuited or circuit-based crossing systems. Where available, crossing system information may be integrated and displayed to the train operator. Crossing system information may include station stop dwell times. Some embodiments may simplify crossing system design as long approaches for preemption become less important or unnecessary. Vehicle speed changes may be accomplished with better efficiency (reduces concern with vehicle speed up on approach). And systems disclosed herein may provide additional opportunities for analytics, such as for automated testing due to every warning time being measurable and measured. Wayside bungalows may be condensed (or eliminated) with the removal of circuited systems.

Another technical effect is that for higher speed vehicles the activation point for a crossing system (for it to flash and lower its barrier) extends further back from the intersection. The same is true for larger trains that require a longer stop distance. For a circuited system, the circuit must extend further to accommodate higher speeds and longer stop distances.

With reference to FIG. 4 one example of the wayside assembly shown. The wayside assembly may include one or more sensors 290 that monitor one or more characteristics of the monitored area of the route. The sensor can represent a camera in one embodiment that outputs static images and/or videos within a field of view 292 of the camera. A controller 294 of the assembly may receive the data output by the sensor or from other sources supplying data to the communication device. The controller may examine the data to make one or more determinations. The controller may determine whether an obstruction is present within the monitored area based on the data, what may be the estimated ToA for the first vehicle, and how to respond. The controller represents hardware circuitry that may include and/or is connected with one or more processors (e.g., one or more microprocessors, integrated circuits, microcontrollers, field programmable gate arrays, etc.) that perform operations described in connection with the camera assembly. Suitable additional or alternative sensors may supply data to the controller. For example, approaching first vehicle may include vehicle-mounted sensors, and the wayside assembly may include a sensor package having one or more of a LiDAR sensor, IR sensor, laser sensor, a radar system, mechanical trips, strain gauges, load cells, etc. The wayside sensors may detect the presence of a vehicle in the intersection or crossing system, or one that is approaching the intersection. An optical sensor may include both the emitter and detector portions as applicable.

The controller can receive the sensor data and examine the sensor data. As noted above, the controller may determine whether an obstruction is present. For example, with respect to image and/or video data, the controller can examine characteristics of pixels in the data to determine whether an obstruction (e.g., a vehicle) has appeared in the field of view of the camera and remain in the field of view for at least a designated period of time (e.g., thirty seconds, sixty seconds, etc.). Optionally, the controller can use one or more object detection algorithms, such as selective searching (grouping pixels having similar characteristics together and determining whether the grouped pixels represent a defined object, such as a vehicle). Alternatively, another object detection algorithm may be used.

As another example, the controller can receive the sensor data and predict when a vehicle will be an obstruction in the intersection or crossing system. For example, the wayside assembly having the sensor may be located away from the intersection or crossing system. The sensor can detect passage of a vehicle and report one or more characteristics of the moving vehicle to the controller. The controller can examine the output from the sensor to predict when the vehicle will be in the intersection. For example, the sensor may sense, or the controller may determine from the sensor output, the direction that the vehicle is moving and/or how fast the vehicle is moving. The controller may know the distance between the sensor and the intersection. Based on this information, the controller can predict when the vehicle will be in the intersection. Optionally, the controller can communicate with the vehicle to receive current speeds and/or headings of the vehicle from the vehicle. The controller may perform this same prediction for one or more other vehicles heading toward the same intersection. The controller can predict whether two or more vehicles will be present in the intersection at the same time. The controller can then notify these vehicles and/or instruct the vehicles to make one or more evasive or responsive actions. For example, the controller can send signals to these vehicles and, in response to receiving these signals, one or more of the vehicles may slow down, stop movement, move onto another route that avoids the intersection or that gets the vehicle to the intersection at a sooner or later time where the predicted collision would be avoided, etc.

The controller optionally can store the sensor data in a tangible and non-transitory computer-readable storage medium (e.g., memory 296 shown in FIG. 4). For example, responsive to determining that the sensor data indicates that an obstruction is present within the monitored area, the controller can direct the memory to electronically and/or magnetically store the sensor data.

Responsive to determining that an obstruction is present in the monitored area, the controller of the camera assembly communicates a signal to another location (e.g., a controller of the crossing system) via a communication device 298. The communication device can represent circuitry that can communicate data signals wirelessly and/or via wired connections. For example, the communication device can represent transceiving circuitry, one or more antennas, modems, or the like, that communicate (e.g., broadcast and/or transmit) a notice signal that indicates detection of an obstruction in the monitored area. This notice signal can be sent before a vehicle approaching the monitored area reaches the monitored area.

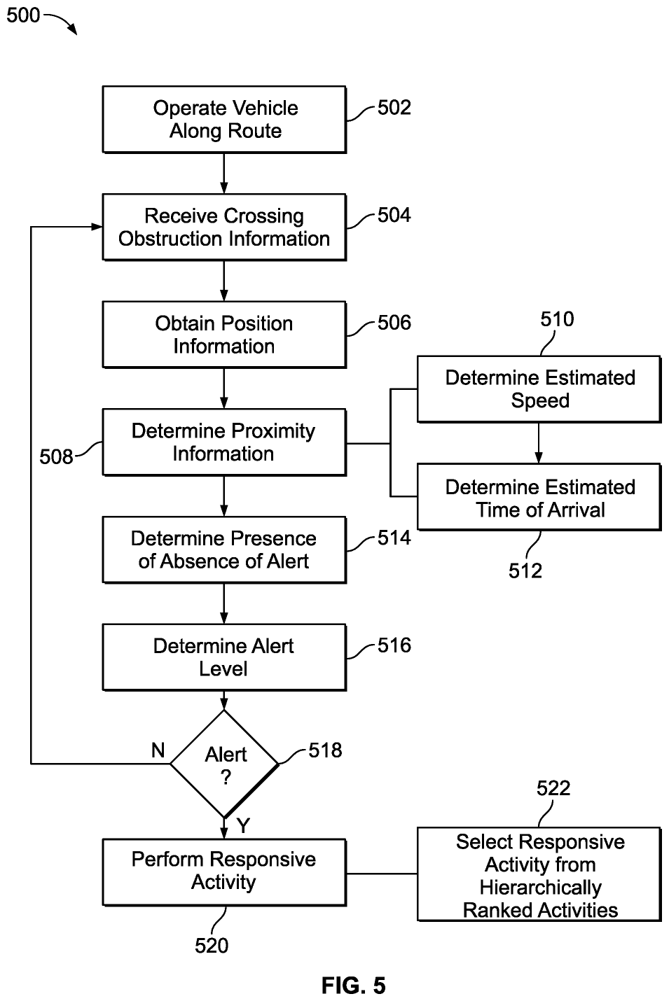

FIG. 5 illustrates a flowchart of one example of a method 500. The method, for example, may employ or be performed by structures or aspects of various embodiments (e.g., systems and/or methods and/or process flows) discussed herein. In various embodiments, certain steps may be omitted or added, certain steps may be combined, certain steps may be performed concurrently, certain steps may be split into multiple steps, certain steps may be performed in a different order, or certain steps or series of steps may be re-performed in an iterative fashion. In various embodiments, portions, aspects, and/or variations of the method may be able to be used as one or more algorithms to direct hardware (e.g., one or more aspects of the controller) to perform one or more operations described herein.

At step 502, a first vehicle is operated to perform a mission and in doing so may travel along a first route. At step 504, during performance of the mission of the vehicle, crossing system obstruction information is received. This may be current obstruction or predicted obstruction (i.e., a potential collision with another vehicle). The sensor data may come from the first vehicle, another vehicle, a wireless transmitter, a conductive track circuit, or a sensor package disposed proximate a crossing system of a route traversed by the first vehicle. One or more crossing systems and/or vehicles may be monitored by corresponding sensors and crossing system obstruction information sent from any sensors that can detect an obstruction or provide data predictive of a potential collision. The crossing system obstruction information indicates or predicts a presence of an obstruction to the crossing system during a time frame. The crossing system obstruction information in various examples may include an identification (e.g., by location) of the particular crossing system that is or will be obstructed, the length of time the crossing system has been or will be obstructed, and/or the type of obstruction. The crossing system obstruction information may be received by a control system (e.g., crossing system obstruction alert system) that is disposed off-board the vehicle in some embodiments, and on-board in others. The illustrated example relates to obstructions and potential obstructions at a crossing system; however, other embodiments may relate to other types of obstructions additionally or alternatively to crossing system obstructions.

At step 506, position information is obtained. The position information indicates a position/direction/speed of the vehicle as it traverses the route. The position information in various examples indicates a geographic position of the vehicle, a position of the vehicle with respect to determined route intervals (e.g., mileposts), and/or a speed and direction of the vehicle. As one example, the position information may be sent from the vehicle (e.g., periodically), or as another example, the position information may be sent from the vehicle pursuant to a request (e.g., from controller) after receipt of crossing system obstruction information or upon handshake communication is established.

At step 508, proximity information of the vehicle is determined (e.g., by the control system receiving the position and crossing system obstruction information). The proximity information indicates how far or close is the vehicle to the crossing system and the ToA of the first vehicle at the intersection. The proximity information may be expressed in terms of distance and/or time from the obstructed crossing system. For example, in the illustrated example, at step 510, an estimated speed of the vehicle is determined, and, at step 512, an estimated time of arrival (ToA) for the vehicle at the obstructed crossing system is determined using the position information (e.g., geographic location) and the estimated/calculated/measured speed of the vehicle. In various examples, the speed of the vehicle may be part of the received position information; may be estimated from a determined trip plan, average speed, or permitted speed limit; or may be determined from multiple location readings over known periods of time.

At step 514, the presence or absence an alert level or a magnitude of risk indicates a potential of the crossing system being obstructed (e.g., at an estimated time of arrival at the crossing system by the vehicle) is determined using the crossing system obstruction information and the proximity information. In the illustrated example, responsive to the determination of an alert or risk level, the level is determined at step 516. The alert level is determined using the proximity information and the crossing system obstruction information. In some examples, the alert level is selected from different hierarchically-ranked alert levels as discussed herein.

At step 518, it is determined if a risk level has been identified that is greater than a determined risk threshold level. If not, the depicted method returns to step 504 to obtain updated crossing system obstruction information and position information to monitor the mission for upcoming potential risks. If there is a risk level above a determined level then at step 520, responsive to the determination of the presence of the risk level being greater than a determined threshold value, a responsive activity is performed. The responsive activity may include, for example, sending an alert to the vehicle (e.g., an operator of the vehicle) and/or sending a command signal to the vehicle altering operation of the vehicle (e.g., applying brakes and/or reducing throttle) lowering a barrier along the intersecting route, flashing lights and generating noise (bell, horn, siren). In one embodiment, emergency response teams are notified. Alternatively or additionally, the responsive activity may include operating crossing system equipment disposed along the route associated with the crossing system, and/or over-riding a current operation of the vehicle (e.g., as performed by an operator).

In the illustrated example, at step 522, the responsive activity is selected from different hierarchically ranked remedial activities corresponding to the alert levels discussed in connection with step 516. The ranked remedial activities may be based at least in part, in some embodiments, on the type and amount of cargo onboard the first vehicle system. For example, a vehicle carrying hazardous cargo may be ranked differently than a vehicle with empty cargo containers. A vehicle with passengers may be ranked differently than one carrying sand or ore.

Functionality provided by the system may include evaluation of the health and state of the crossing system equipment, as well as information as to whether the cross route is (or will be) clear. The functionality may calculate an estimated time of arrival (ETA) of the vehicle system at the crossing system, or at a determined point of no return. The point of no return is the point at which braking will not stop the vehicle from entering the intersection or crossing system. The controller can determine if it is acceptable for the vehicle to approach, and to traverse, the crossing system. In one embodiment, the onboard controller may send a “Crossing system Start Request” to the crossing system equipment. The crossing system equipment may send back an acknowledgement of receipt, and optionally additional information. The additional information may be whether the ETA is acceptable. The onboard controller may check the crossing system equipment and receive a “STOP” or “NOT CLEAR” or “UNSURE OF CLEARANCE” response. The onboard controller may, in this mode, inhibit the crossing system equipment activation system. Activation may be inhibited for the duration of an inhibition signal from the onboard controller. The crossing system equipment may activate once the onboard controller stops broadcasting an inhibit signal and/or when the onboard controller signals a station release message to the crossing system equipment.

A data repository of the collected data may be created and populated with the retrieved data from the crossing system and/or the vehicles that traverse the intersection. Date from the repository may be analyzed and may be selectively retrieved remotely from the crossing system.

In one embodiment, the crossing system may have a controller and/or sensor package. A local data collection system may be deployed that may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the controller may include a policy engine that may apply one or more policies. These policies may be based at least in part on characteristics of a given item of equipment or environment. With respect to control policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models is obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

The controller can use this artificial intelligence or machine learning to receive input (e.g., a current location, heading, and/or moving speed of each vehicle), and use a model that associates different combinations of locations, headings, and/or moving speeds with different responsive actions and/or likelihoods of collisions at intersections. The controller can use this model to select a responsive action and/or likelihood of collision, and then provide an output (e.g., the selected responsive action and/or likelihood of collision calculated using the model). The controller may receive additional input of the result of implementing the responsive action that indicates whether the machine-selected responsive action provided a desirable outcome or not (e.g., by avoiding a collision or when the likelihood of collision indicates a low likelihood of collision when a collision does, in fact, occur). Based on this additional input, the controller can change the model, such as by changing which responsive action would be selected and/or the likelihood of collision that is calculated when a similar or identical combination of location, heading, and/or moving speed is received in the iteration of using the model. The controller can then use the changed or updated model again to select a responsive action and/or calculate a likelihood of confusion, receive feedback on the selected responsive action or whether a collision actually occurs, change or update the model again, etc., in additional iterations to repeatedly improve or change the model using artificial intelligence or machine learning.

In one example, the method may be for detecting or predicting potential collisions and may include receiving sensor output indicative of one or more of a location, a heading, or a moving speed of one or more of a first vehicle or a second vehicle, predicting a collision between the first vehicle and the second vehicle at an intersection between two or more routes based on the sensor output that is received, and changing movement of the one or more of the first vehicle or the second vehicle responsive to the collision that is predicted.

The sensor output that is received may include optical data output by one or more optical sensors disposed at the intersection between the two or more routes and/or disposed away from the intersection between the two or more routes. The first and second vehicles may be the same type of vehicle or may be different types of vehicles. The movement of the first and/or second vehicle may be changed autonomously by communicating a signal to the one or more of the first vehicle or the second vehicle. The sensor output may be received from one or more non-optical sensors. The collision may be predicted by calculating a likelihood of collision using an artificial intelligence or machine learning model.

In one example, the collision detection system may include a controller that receive sensor output indicative of one or more of a location, a heading, or a moving speed of one or more of a first vehicle or a second vehicle. The controller may predict a collision between the first vehicle and the second vehicle at an intersection between two or more routes based on the sensor output that is received, and may change movement of the one or more of the first vehicle or the second vehicle responsive to the collision that is predicted.

The controller may receive the sensor output by receiving optical data output by one or more optical sensors disposed at the intersection between the two or more routes. The controller may receive the sensor output by receiving optical data output by one or more optical sensors disposed away from the intersection between the two or more routes. The first vehicle and the second vehicle may be the same type of vehicle or may be different types of vehicles. The controller may autonomously change the movement of the one or more of the first vehicle or the second vehicle by communicating a signal to the one or more of the first vehicle or the second vehicle. The controller may receive the sensor output from one or more non-optical sensors.

In one example, a crossing system may include a controller that can receive sensor output indicative of one or more of a location, a heading, or a moving speed of a first automobile and a second automobile. The controller may predict a collision between the first automobile and the second automobile at an intersection between two or more roads based on the sensor output that is received and using an artificial intelligence or machine learning model. The controller may autonomously change movement of the one or more of the first automobile or the second automobile responsive to the collision that is predicted.

The controller may receive the sensor output by receiving optical data output by one or more optical sensors disposed at the intersection between the two or more routes. The controller may autonomously change the movement of the one or more of the first vehicle or the second vehicle by communicating a signal to the one or more of the first vehicle or the second vehicle. The controller may receive the sensor output from one or more non-optical sensors.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term may include tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
receiving a wireless signal indicative of one or more of a location, a heading, or a moving speed of a first vehicle;
predicting a time of arrival of the first vehicle at an intersection based at least in part on the signal received; and
activating at least one of a barrier and a notification at a time in a determined range of times prior to the predicted time of arrival, and thereby to prevent, warn or block a second vehicle from entering the intersection.

2. The method of claim 1, further comprising obtaining or predicting a time of arrival of the second vehicle at the intersection, and changing movement of one or more of the first vehicle or the second vehicle responsive to an overlap in times of arrival to avoid both vehicles being in or at the intersection at the same time.

3. The method of claim 1, further comprising obtaining information about the location, heading or moving speed of the first vehicle from a positive vehicle control system onboard the first vehicle.

4. The method of claim 3, wherein obtaining information about the location, heading or moving speed of the first vehicle comprises referencing an onboard route database.

5. The method of claim 1, wherein receiving the wireless signal occurs at a crossing system that is proximate the intersection, and further comprising attempting to establish a communication connection between the crossing system and the first vehicle.

6. The method of claim 5, wherein the communication connection is not established, and the first vehicle responds by slowing or stopping.

7. The method of claim 5, wherein the communication connection is established, and further comprising receiving a second wireless signal at the first vehicle from the crossing system that contains information indicative of at least one of health or condition of the crossing system and status of the intersection.

8. The method of claim 1, wherein a conductive circuit defines an island around the intersection, the conductive circuit being configured to detect a presence of the first vehicle and to determine one or both of a distance and a speed of the first vehicle relative to the intersection, and further comprising predicting a time of arrival of the first vehicle at the intersection based at least in part on the conductive circuit.

9. The method of claim 1, further comprising determining when the first vehicle has completely exited the intersection based at least in part on the wireless signal and information regarding a length of the first vehicle.

10. The method of claim 1, further comprising displaying information to an operator of the first vehicle relating to an upcoming crossing system/intersection with crossing system equipment, the displayed information comprising at least one of a distance to the crossing system, a time of arrival to the crossing system, a health status of the crossing system equipment, an aspect of the crossing system, a type of the crossing system equipment, a physical layout of the crossing system, a status of the crossing system being active or non-active, a status of the intersection being obstructed or non-obstructed, and a braking envelope of the first vehicle relative to the intersection.

11. The method of claim 1, further comprising monitoring the intersection for occupation or obstruction of the intersection.

12. A system, comprising:
a controller onboard a first vehicle configured to:
attempt to establish a communication connection with a communication device of a crossing system disposed proximate to an intersection;
send a wireless signal indicative of one or more of a location, a heading, or a moving speed of the first vehicle; and at least one of:
obtain confirmation from the communication device that the crossing system is functioning properly and is acting, or will act, to prevent any second vehicle from being in the intersection at a time of arrival;
obtain information from the communication device that the intersection is obstructed, or will be obstructed at the time of arrival; and
determine a time of arrival of the first vehicle at the intersection, and slow or stop the first vehicle prior to entering into the intersection if the communication connection is not established.

13. The system of claim 12, further comprising the crossing system that is configured to one or more of:
determine a time of arrival of the first vehicle at the intersection;
signal wirelessly the time of arrival to the first vehicle;
determine if the intersection is obstructed;
block the intersection with a selectively movable barrier;
notify other vehicle occupants of an incoming vehicle along another route to the intersection;
determine a length of the first vehicle;
determine a degree of slack or compression of the first vehicle; and
determine when the first vehicle has left the intersection, and remove any barriers or notifications.

14. The system of claim 13, further comprising a conductive circuit that is configured to determine that the first vehicle has contacted the conductive circuit.

15. The system of claim 14, wherein the crossing system is further configured to determine one or more of a location, heading, and movement speed based on both of the wireless signal and the conductive circuit.

16. The system of claim 13, wherein the crossing system is further configured to obtain or predict an time of arrival of a second vehicle at the intersection, and is configured to change a movement of the one or more of the first vehicle or the second vehicle responsive to overlap of the times of arrival to avoid both vehicles being in or at the intersection at the same time.

17. The system of claim 12, wherein the controller is configured to obtain information about the location, heading or moving speed of the first vehicle referencing a positive vehicle control system onboard the first vehicle.

18. The system of claim 12, further comprising a display unit onboard the first vehicle, and the controller is configured to display, on the display unit to an operator of the first vehicle, information relating to an upcoming crossing system/intersection comprising at least one of a distance to the crossing system, a time of arrival to the crossing system, a health status of crossing system equipment, an aspect of the crossing system, a type of the crossing system equipment, a physical layout of the crossing system, a status of the crossing system being active or non-active, a status of the intersection being obstructed or non-obstructed, and a braking envelope of the first vehicle relative to the intersection.

19. A system, comprising:
a controller comprising one or more processors that are disposed onboard a first vehicle, and the controller is configured to determine a location, heading or speed of the first vehicle based at least in part from a positive train control track database;
a crossing system that is configured to receive data wirelessly from the controller, and to activate a barrier and/or notifications at a determined time prior to an arrival of the first vehicle at an intersection proximate to the crossing system;
a wireless communication system configured to provide a communication connection between the controller and the crossing system; and
one or both of the controller and crossing device being further configured to determine the time of arrival of the first vehicle at the intersection based at least in part on the location, heading and/or speed of the first vehicle.

20. The system of claim 19, wherein the controller is configured to obtain a location of the intersection and respond to a failure to establish communication with the crossing system within a determined distance from the crossing system responds by slowing or stopping the first vehicle prior to its entry into the intersection.
